(19) United States
(12) Patent Application Publication
(10) Pub. No.: US 2013/0322888 A1
(43) Pub. Date: Dec. 5, 2013

(54) OPTICAL TRANSMISSION CIRCUIT DEVICE, OPTICAL RECEPTION CIRCUIT DEVICE, OPTICAL TRANSMISSION/RECEPTION CIRCUIT DEVICE AND OPTICAL TRANSMISSION METHOD

(71) Applicant: KABUSHIKI KAISHA TOSHIBA, Tokyo (JP)

(72) Inventors: Hideto FURUYAMA, Kanagawa-ken (JP); Hiroshi UEMURA, Kanagawa-ken (JP)

(73) Assignee: KABUSHIKI KAISHA TOSHIBA, Tokyo (JP)

(21) Appl. No.: 13/782,586

(22) Filed: Mar. 1, 2013

(30) Foreign Application Priority Data
Jun. 4, 2012 (JP) P2012-127177

(51) Int. Cl. H04B 10/00

(52) U.S. Cl. CPC H04B 10/12
USPC 398/141; 398/202; 398/200

(57) ABSTRACT

An optical transmission circuit device generates first and second optical signals from differential set and reset signals each time digital electric input signals of N bits are received. The differential set signal indicates an increase in signal strength relative to immediately preceding N bits of the digital electric input signals and the differential reset signal indicates a decrease in signal strength relative to the immediately preceding N bits. An optical reception circuit device generates first and second digital signals from the first and second optical signals and a third digital signal from the first and second digital signals, a magnitude of the third digital signal being increased by the first digital signal and decreased by the second digital signal. The optical reception circuit further generates a digital output signal of N bits from the third digital signal and an immediately preceding N bits of the digital output signal.

### CROSS REFERENCE

This application is based upon and claims the benefit of priority from Japanese Patent Application No, 2012-127177, filed on Jun. 4, 2012, the entire contents of which are incorporated herein by reference.

### FIELD

Embodiments of the present application relate to an optical transmission circuit device, an optical reception circuit device, an optical transmission/reception circuit device and an optical transmission method.

### BACKGROUND

In recent years, the amount of signals processed in information communication devices has increased due to enhanced performance of electronic devices and an increase in size of multimedia content. As a result, signal transmission speeds inside and outside the electronic devices has increased, requiring a further reduction in transmission loss and electromagnetic noise interference. To achieve this purpose, various optical transmission circuits have been proposed.

### BRIEF DESCRIPTION OF THE DRAWINGS

FIG. 1 is a schematic circuit diagram illustrating an optical transmission/reception circuit device according to a first embodiment.

FIG. 2 is a schematic waveform diagram illustrating a waveform at each point shown in FIG. 1.

FIGS. 3A-3C are schematic waveform diagrams for explaining a multiplexing method separate from FIG. 2.

FIG. 4 is a schematic block diagram illustrating an example of the transmission circuit and the reception circuit used in the optical transmission/reception circuit shown in FIG. 1.

FIG. 5 is a schematic block diagram illustrating another example of the transmission circuit and the reception circuit used in the optical transmission/reception circuit shown in FIG. 1.

FIG. 6 is a schematic circuit diagram illustrating an optical transmission/reception circuit device according to a second embodiment.

FIG. 7 is a schematic waveform diagram illustrating a waveform at each point shown in FIG. 5.

FIG. 8 is a schematic block diagram illustrating an example of the transmission circuit and the reception circuit used in the optical transmission/reception circuit shown in FIG. 5.

FIG. 9 is a schematic block diagram illustrating another example of the transmission circuit and the reception circuit used in the optical transmission/reception circuit shown in FIG. 5.

### DETAILED DESCRIPTION OF THE EMBODIMENTS

Embodiments provide a low power optical transmission/reception circuit device and an optical transmission method.

An optical transmission/reception system includes an optical transmission circuit device and an optical reception circuit device. The optical transmission circuit device generates first and second optical signals from differential set and reset signals each time digital electric input signals of N bits are received. The differential set signal indicates an increase in signal strength relative to immediately preceding N bits of the digital electric input signals and the differential reset signal indicates a decrease in signal strength relative to the immediately preceding N bits. The optical reception circuit device generates first and second digital signals from the first and second optical signals and a third digital signal from the first and second digital signals, a magnitude of the third digital signal being increased by the first digital signal and decreased by the second digital signal. The optical reception circuit further generates a digital output signal of N bits from the third digital signal and an immediately preceding N bits of the digital output signal.

Embodiments are explained in detail below with reference the drawings.

### First Embodiment

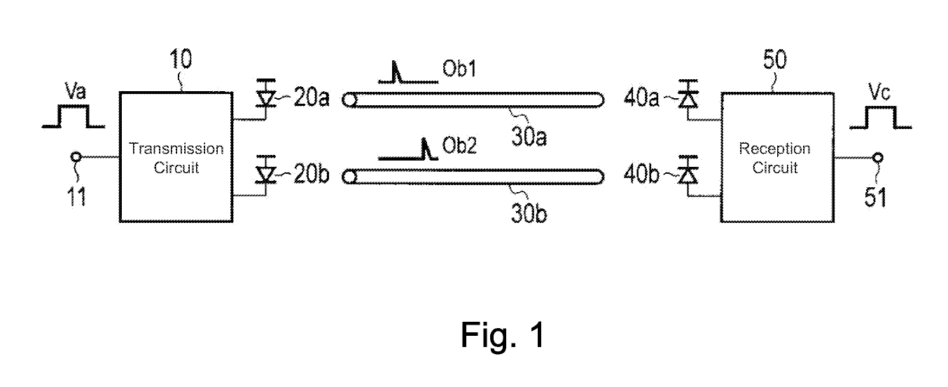

FIG. 1 is a schematic circuit diagram illustrating an optical transmission/reception circuit device according to a first embodiment.

In the figure, reference number 10 is a transmission circuit. Reference number 11 is an input terminal for digital electric input signals. Reference number 20a is a first light emission element. Reference number 20b is a second light emission element. Reference number 30a is a first optical transmission path. Reference number 30b is a second optical transmission path. Reference number 40a is a first light reception element. Reference number 40b is a second light transmission element. Reference number 50 is a reception circuit. Reference number 51 is an output terminal for digital electric output signals.

In the optical transmission/reception circuit device shown in FIG. 1, the transmission circuit 10 compares a digital electric input signal Va at N-bit unit (N is an integer equal to or greater than 2) in the order of reception from an input terminal 11 and generates a first electric pulse signal, in which an amount increased from an immediately preceding N bits is multiplexed in a 2^{N} value, and a second electric pulse signal, in which an amount decreased from an immediately preceding N bits is multiplexed in a 2^{N} value. Then, the first light emission element 20a converts the first electric pulse signal into a first optical signal Ob1, and the second light emission element 20b converts the second electric pulse signal into a second optical signal Ob2.

The first optical signal Ob1 is transmitted through the first light transmission path 30a and is converted into a third electric pulse signal at the first light reception element 40a. The second optical signal Ob2 is transmitted through the second light transmission path 30b and is converted into a fourth electric pulse signal at the second light reception element 40b. The reception circuit 50 is configured to generate a digital electric output signal Vc that corresponds to the digital electric input signal Va, from the third and fourth electric pulse signals.

All of the first electric pulse signal, the first optical signal and the third electric pulse signal are differential set signals, in which digital electric input signals are compared at the N-bit unit in the order of reception and in which the amount of increase from the immediately preceding N bits is multiplexed in a 2^{N} value. All of the second electric pulse signal, the second optical signal and the fourth electric pulse signal are differential reset signals, in which digital electric input signals are compared at the N-bit unit in the order of reception and in which the amount of decrease from the immediately preceding N bits is multiplexed in a 2^{N} value.

The digital electric output signal Vc that corresponds to the digital electric input signal Va preferably includes digital information that is the same as that of the digital electric input signal Va and is preferably in the same signal format. However, it should be understood that the waveform may not be completely identical due to noise, jitter, inter symbol interference (ISI) and the like generated at the time of signal processing and transmission.

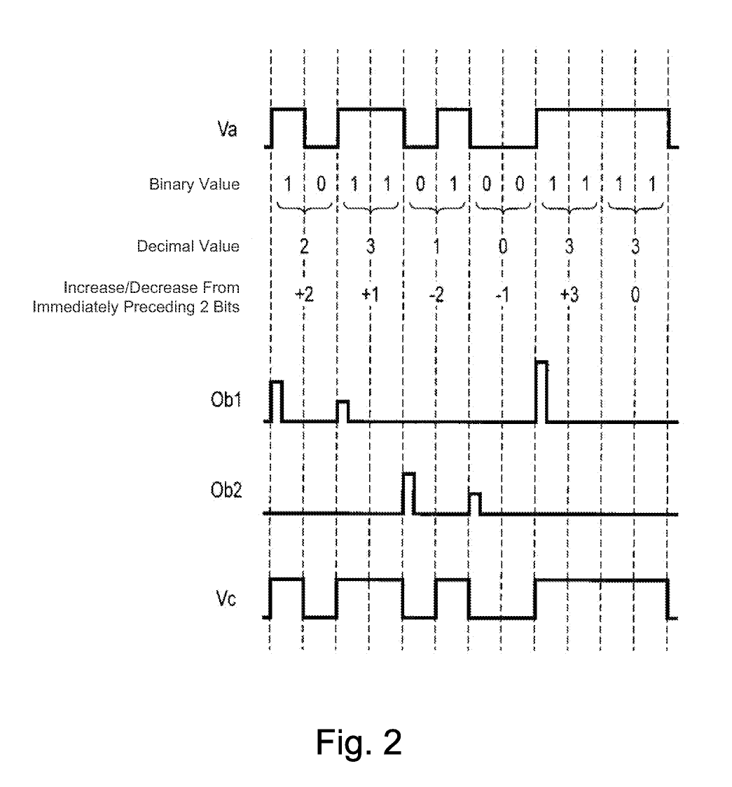

FIG. 2 is a schematic waveform diagram illustrating waveforms at Va, Ob1, Ob2 and Vc in FIG. 1. Using this figure, the multiplexing method of the optical transmission/reception circuit device is explained. FIG. 2 illustrates a case when N=2. However, the present embodiment is applicable when N is 2 or greater. In FIG. 2, conversion from a binary value to a decimal value is illustrated for the purpose of explanation. However, this is merely for the purpose of explanation. The signal processing at the transmission circuit 10 is preferably performed with the binary value as is. For assisting the understanding, the operation time of the circuit and the transmission time for the signal are ignored in FIG. 2, and the timings for transmission of the digital electric input signal Va, the first and second optical signals Ob1 and Ob2, and the digital electric output signal Vc are configured at the same timing.

In the example shown in FIG. 2, the optical transmission/reception circuit device compares the digital electric input signal Va at 2-bit unit in the order of reception. In FIG. 2, the binary value of the digital electric input signal Va is converted into a decimal value at 2-bit unit, and the difference from the immediately preceding 2-bits is described in a decimal value. The value of the immediate preceding 2 bits is 0 for the initial 2 bits.

When the difference from the immediately preceding 2 bits increases, the transmission circuit 10 generates the first electric pulse signal having amplitude corresponding to a value of the difference, and thereby the first optical signal Ob1 is generated by the light emission element 20a. In addition, when the difference from the immediately preceding 2 bits decreases, the second electric pulse signal having amplitude corresponding to a value of the difference is generated, and thereby the second optical signal Ob2 is generated by the light emission element 20b. When the difference from the immediately preceding 2 bits is 0, the first and second electric pulse signals are not generated.

In FIG. 2, the first and second optical signals are defined as optical signals in which the amplitude is multiplexed by a value of 2²=4. More specifically, the amplitude at the time when the difference from the immediately preceding 2 bits is ±2 or ±3 is configured twice or three times of that at the time when the difference is ±1. Moreover, the pulse width of the first and second optical signals is configured smaller than the smallest pulse of the digital electric input signal. As a result, the light emission amount is reduced, and the optical power decreases.

Next, when the reception circuit 50 receives the third electric pulse signal generated from the first optical signal Ob1 by the light reception element 40a, the reception circuit 50 increases the digital electric output signal by a 2-bit unit in accordance with an amplitude value of the third electric pulse signal. In addition, when the reception circuit 50 receives the fourth electric pulse signal generated from the second optical signal Ob2 by the light reception element 40a, the digital electric output signal is decreased by a 2-bit unit in accordance with the amplitude value of the fourth electric pulse signal. If the third and fourth electric pulse signals are not received, 2 bits that are the same as the immediately preceding 2 bits are outputted at predetermined timing.

More specifically, at the initial 2 bits, as the amplitude of the first optical signal Ob1 is “2,” “00” is increased by “2” and becomes “10.” At the next 2 bits, as the amplitude of the optical signal Ob1 is “1,” “10” is increased by “1” and becomes “11.” At the next 2 bits, as the amplitude of the second optical signal Ob2 is “−2,” “11” is decreased by “2” and becomes “01.”

In the optical transmission/reception circuit device of the present embodiment, the optical transmission is performed by comparing the digital electric input signal Va at N-bit unit and by multiplexing the difference from the immediately preceding N bits in a 2^{N} value. As a result, because the optical signal is generated only at the N-bit unit, the occurrence frequency of the optical signals is reduced, thereby allowing reduction of power. In particular, when a digital electric signal in which the values are repeated at the N-bit unit (e.g., 000000 . . . , 111111 . . . , 010101 . . . , and 101010 . . . when N=2) is inputted, the difference from the immediately preceding N bits is always 0. Therefore, the optical signal is not generated, resulting in the most power reduction.

In the optical transmission/reception circuit device of FIG. 1, when a digital electric input signal, in which 0's continuous for N bits and 1's continuous for N bits alternate, is inputted, the difference from the immediately preceding N bits is ±(2^{N}−1). Therefore, the amplitude of the first and second optical signals in such cases is the maximum, resulting in the largest power consumption. More specifically, when the smallest bit width of the digital electric input signal is B, when the bit width of the first and second optical signals is b, and when the minimum amplitude value of the first and second optical signals (corresponding to the case when the difference from the immediately preceding N bits is ±1) is “1,” the power of the optical signal per unit time is (2^{N}−1)·b/(N·B) because the first or second optical signal having the amplitude (2^{N}−1) are generated for each N bits of the digital electric input signal.

On the other hand, the power of the optical signal per unit time in the case when the above-described digital electric input signal is optically transmitted using a direct modulation method that converts the digital electric input signal into the optical signal as is, is 0.5, which is equal to a mark ratio (ratio of 1's and 0's) of the above-described digital electric input signal, provided that the amplitude value of the optical signal is “1” that is equal to the minimum amplitude value for the first and second optical signals. As a result, the power of the optical signal is smaller than that using the direct modulation method if the bit width b of the first and second optical signals is configured smaller than N·B/{2·(2^{N}−1)}.

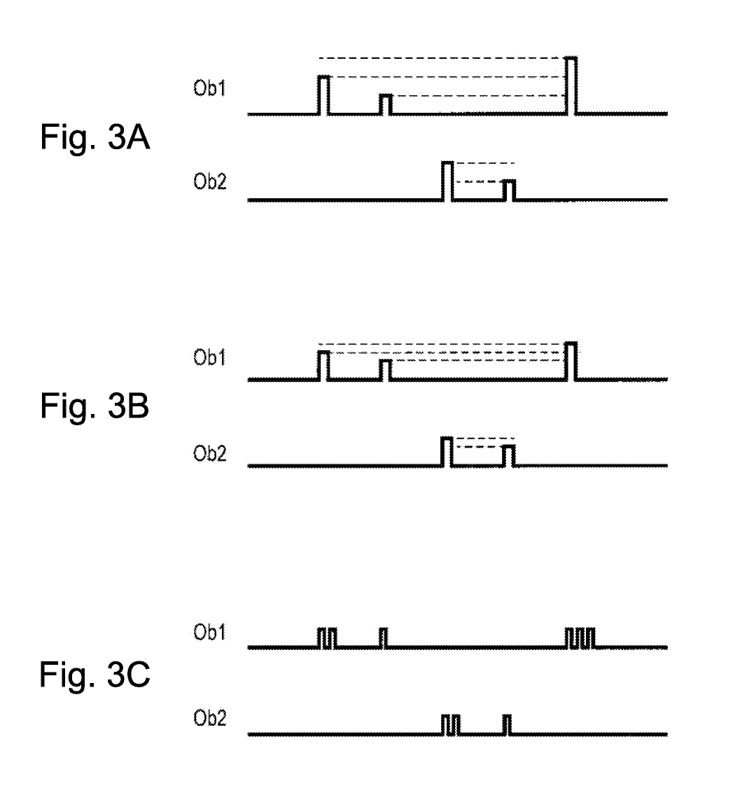

In the above-described example, as shown in FIG. 3A, the amplitude of the first and second optical signals is configured such that the values of increase and decrease from the respective amplitudes become the same as the smallest amplitude value. However, as shown in FIG. 3B, the amplitude of the first and second optical signals may be configured such that the values of increase and decrease from the respective amplitudes become smaller than the smallest amplitude value. As a result, further decrease of optical power by reducing the light emission amount is possible. Moreover, the values of increase and decrease from the respective amplitudes may be appropriately configured based on resolving power of the amplitude value of the reception circuit 50.

Further, as shown in FIG. 3C, an optical signal, in which the pulse number is multiplexed in the 2^{N} value, may be used instead of varying the amplitude. As a result, decrease of optical power by reducing the light emission amount is possible. In this case, (2^{N}−1) optical signals are generated between the N bits of the digital electric input signal at most. Therefore, it is preferable that the pulse interval of the first and second optical signals is set to N·B/(2^{N}−1) or less and that the pulse width of the first and second optical signals is set to N·B/{2·(2^{N}−1)} or less, when the minimum bit width of the digital electric input signal is B.

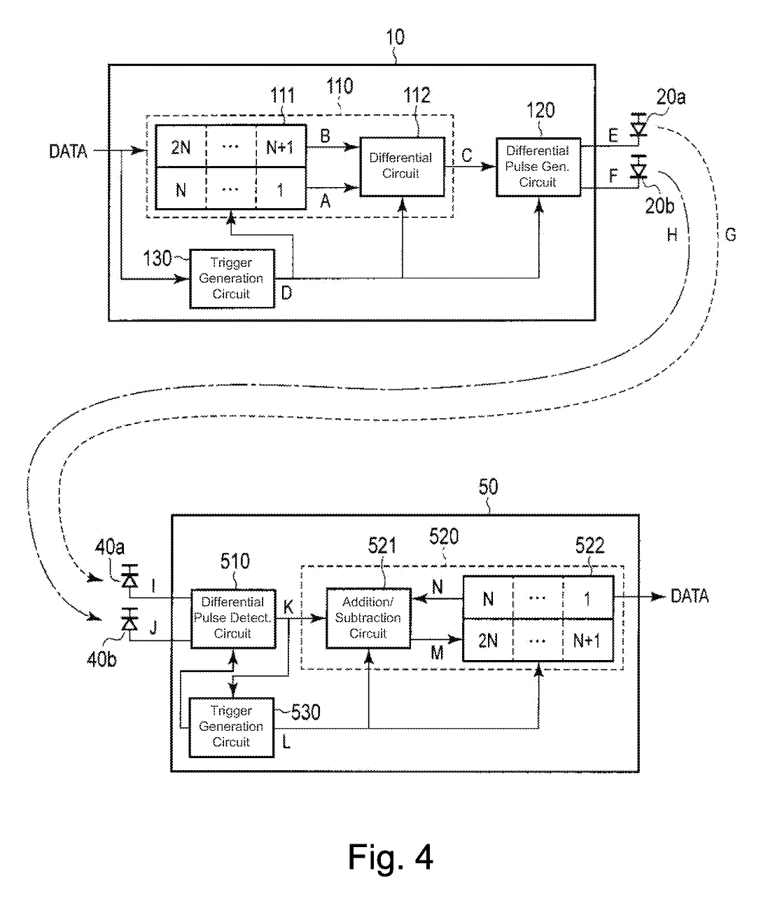

FIG. 4 illustrates a schematic block diagram showing an example of a specific configuration of the transmission circuit 10 and the reception circuit 50.

The transmission circuit 10 in FIG. 4 receives the digital electric input signal (DATA) and generates the first electric pulse signal (E) and the second electric pulse signal (F). The transmission circuit 10 includes an N-bit differential circuit 110, a differential pulse generation circuit 120 and a trigger generation circuit 130.

The N-bit differential circuit 110 compares the digital electric input signal at N-bit unit in the order of reception and outputs a difference value (increase value and decrease value) from the immediately preceding N bits. As shown in FIG. 4, the N-bit differential circuit 110 is configured from a shift register 111 and a differential circuit 112. The shift register 111 holds each bit of the digital electric input signal in the order of reception. The differential circuit 112 compares the immediately preceding N bits (1, . . . , N) (A) and the current N bits (N+1, . . . , 2N) (B) held in the shift register 111 for each N bits of the digital electric input signal and outputs a difference value (C) from the immediately preceding N bits.

The differential pulse generation circuit 120 generates the first electric pulse signal (E), in which the difference value is multiplexed in a 2^{N} value, when the difference value is an increase value, and generates the second electric pulse signal (F), in which the difference value is multiplexed in a 2^{N} value, when the difference value is a decrease value,

The trigger generation circuit 130 of the transmission circuit 10 generates a trigger signal (D) based on the digital electric input signal. For example, a clock data recovery circuit may be used that extracts a clock signal from a data signal. To operate the above-described N-bit differential circuit 110 and the differential pulse generation circuit 120, it is preferred that, in the transmission circuit 10, a trigger signal is inputted to the shift register 111 for each bit of the digital electric input signal, and that the trigger signal is inputted to the differential circuit 112 and the differential pulse generation circuit 120 for each N bits of the digital electric input signal. That is, the trigger generation circuit 130 is preferably capable of generating both of the trigger signals for each bit and for each N bits of the digital electric input signal. Alternatively, a divider circuit that generates the trigger signals for each N bits of the digital electric input signal from the trigger signals for each bit of the digital electric input signal.

The reception circuit 50 in FIG. 4 receives a third electric pulse signal (I) and a fourth electric pulse signal (J) and generates the digital electric output signal (DATA). The reception circuit 50 includes a differential pulse detection circuit 510, an N-bit addition/subtraction circuit 520 and a trigger generation circuit 530.

The differential pulse detection circuit 510 receives the third electric pulse signal (I) in which the increase value for each N bits of the digital electric input signal is multiplexed in a 2^{N} value, and the fourth electric pulse signal (J) in which the decrease value for each N bits of the digital electric input signal is multiplexed in a 2^{N} value, and detects a difference value (increase value and decrease values) (K) for each N bits of the digital electric input signal.

The N bit addition/subtraction circuit 520 generates the next N bits of the digital electric output signal by adding the difference value (K) to the immediately preceding N bits of the digital electric output signal when the difference value is an increase value and by subtracting the difference value (K) from the immediately preceding N bits of the digital electric output signal when the difference value is a decrease value. As shown in FIG. 4, the N bit addition/subtraction circuit 520 is configured from an addition/subtraction circuit 521 and a shift register 522. The shift register 522 holds and sequentially transmits each bit of the digital electric output signal. For each N bits of the digital electric output signal, the addition/subtraction circuit 521 adds or subtracts the difference value (K) to or from the immediately preceding N bits (1, . . . , N) (N) held in the shift register and generates the next N bits (N+1, . . . 2N) (M).

The trigger generation circuit 530 of the reception circuit 50 generates a trigger signal (L) based on the output of the differential pulse detection circuit 510. In the reception circuit 50, for operating the above-described differential pulse detection circuit 510 and N-bit addition/subtraction circuit 520, it is preferable that the trigger signal is inputted to the shift register 522 for each bit of the digital electric output signal and that the trigger signal is inputted to the differential pulse detection circuit 510 and the addition/subtraction circuit 521 for each N bits of the digital electric output signal.

The trigger signal generation circuit 530 may generate the trigger signal based on an internal signal of the differential pulse detection circuit 510 or based on the third and fourth electric pulse signals. Alternatively, the trigger signal for the transmission circuit 10 may be transmitted to the reception circuit 50 to be used as the trigger signal for the reception circuit 50. The transmission of the trigger signal from the transmission circuit 10 to the reception circuit 50 may be performed by using optical signal or electric signals. When the optical signals are used, there is an advantage that a signal transmission delay time difference (skew) between the first and second optical signals and the trigger signal may be minimized. When the electric signals are used, there are advantages to reduce the cost by reducing the number of the light emission elements and the light reception elements because the transmission of optical signals is unnecessary and to reduce electric power required for the signal transmission because the optical signals need not be generated.

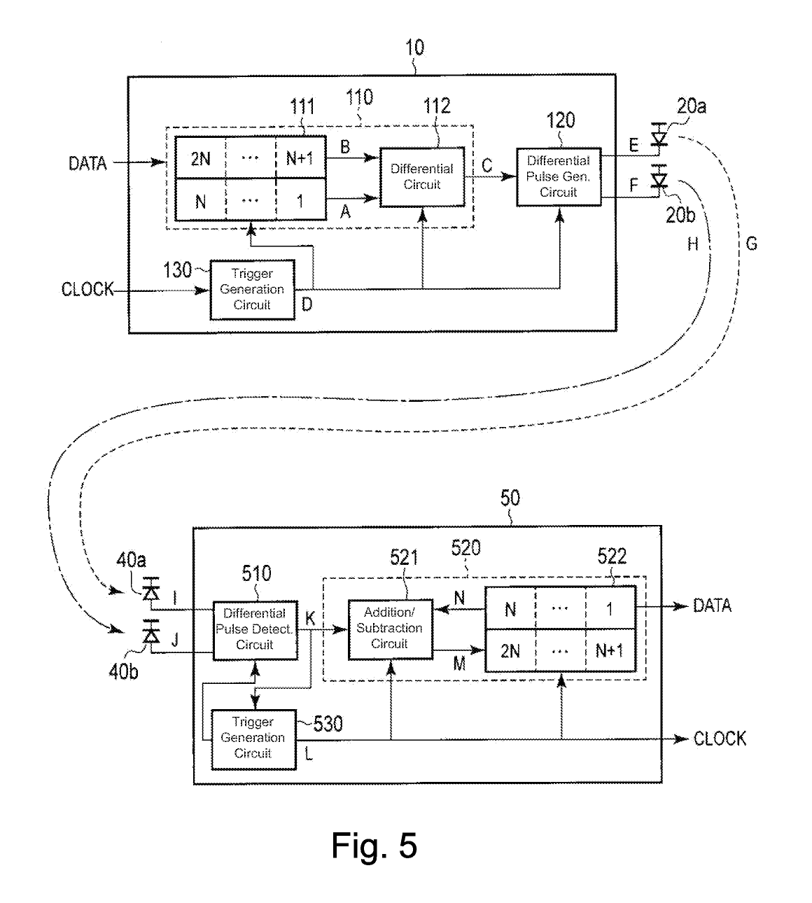

FIG. 4 illustrates an example in which the trigger signal is generated from the digital electric input signal at the transmission circuit 10. However, as shown in FIG. 5, a clock signal (CLOCK) that is synchronized with the digital electric input signal may be inputted externally to generate the trigger signal based on the received clock signal. Moreover, the trigger signal generated by the trigger generation circuit 530 in the reception circuit 50 may be outputted as the clock signal (CLOCK) that is synchronized with the digital electric output signal.

As described above, according to the present embodiment, the digital electric input signals Va is compared at N bit unit in the order of reception. The first optical signal Ob1 is generated by multiplexing the amount of increase from the immediately preceding N bits to a 2^{N} value and is transmitted. Moreover, The second optical signal Ob2 is generated by multiplexing the amount of decrease from the immediately preceding N bits to a 2^{N} value and is transmitted. As a result, the occurrence frequency of the optical signals is reduced, thereby allowing reduction of the light emission amount for the optical transmission. Therefore, the tow power optical transmission can be achieved.

### Second Embodiment

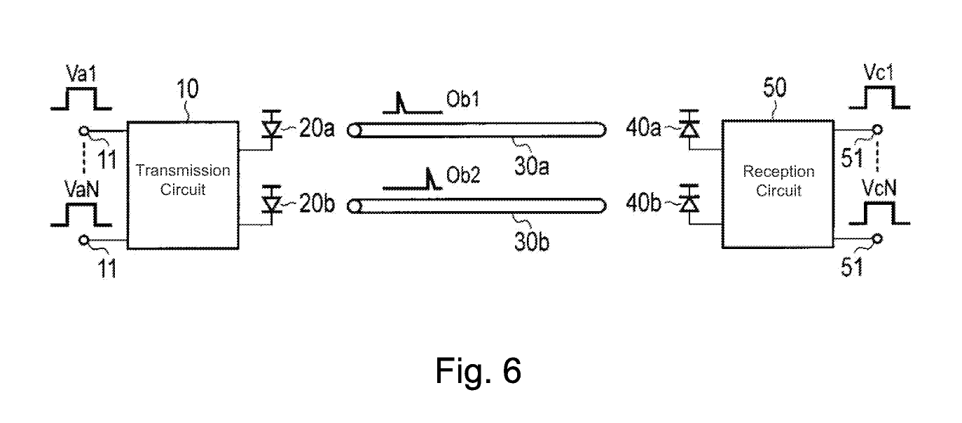

FIG. 6 is a schematic circuit diagram illustrating an optical transmission/reception circuit device according to a second embodiment and differs from FIG. 1 on a point that the number of systems of signal transmission is N (N is an integer equal to or greater than 2). Parts that are the same as those shown in FIG. 1 are indicated with the same symbols. Details explanations of such parts are omitted.

In the optical transmission/reception circuit device shown in FIG. 6, the transmission circuit 10 receives N-system digital electric input signals Va1, . . . , VaN from an input terminal 11, compares each bit of the N-system electric input signals Va1, . . . , VaN arranged in the order of systems, and generates a first electric pulse signal, in which an amount increased from an immediately preceding N bits is multiplexed in a 2^{N} value, and a second electric pulse signal, in which an amount decreased from an immediately preceding N bits is multiplexed in a 2^{N} value. Then, the first light emission element 20a converts the first electric signal into a first optical signal Ob1, and the second light emission element 20b converts the second electric signal into a second optical signal Ob2.

The first optical signal Ob1 is transmitted through the first light transmission path 30a and is converted into a third electric pulse signal at the first light reception element 40a. The second optical signal Ob2 is transmitted through the second light transmission path 30b and is converted into a fourth electric pulse signal at the second light reception element 40b. The reception circuit 50 is configured to generate N-system digital electric output signals Vc1, . . . , VcN that correspond to the N-system digital electric input signals, from the third and fourth electric pulse signals.

Also in the present embodiment, all of the first electric pulse signal, the first optical signal and the third electric pulse signal are differential set signals, in which digital electric input signals are compared at the N-bit unit in the order of reception and in which the amount of increase from the immediately preceding N bits is multiplexed in a 2^{N} value. All of the second electric pulse signal, the second optical signal and the fourth electric pulse signal are differential reset signals, in which digital electric input signals are compared at the N-bit unit in the order of reception and in which the amount of decrease from the immediately preceding N bits is multiplexed in a 2^{N} value.

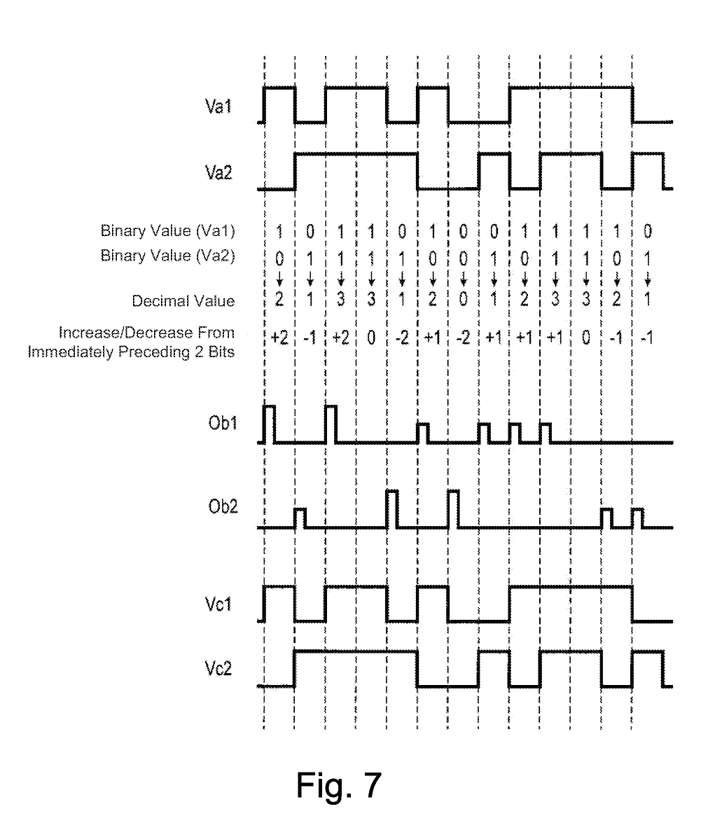

FIG. 7 is a schematic waveform diagram illustrating waveforms at Va1 to VaN, Ob1, Ob2, and Vc1 to VcN shown in FIG. 6. Using this figure, the multiplexing method of the optical transmission/reception circuit device is explained. FIG. 7 illustrates a case when N=2. However, the present embodiment is applicable when N is 2 or greater. In FIG. 7, conversion from a binary value to a decimal value is illustrated for the purpose of explanation. However, this is merely for the purpose of explanation. The signal processing at the transmission circuit 10 is preferably performed with the binary value as is. For assisting the understanding, the operation time of the circuit and the transmission time for the signal are ignored in FIG. 7, and the timings for transmission of the digital electric input signals Va1 and Va2, the first and second optical signals Ob1 and Ob2, and the digital electric output signals Vc1 and Vc2 are configured at the same timing.

In the example shown in FIG. 7, the optical transmission/reception circuit device receives the 2-system digital electric input signals Va1 and Va2 and compares for each bit at 2-bit unit arranged in the order of the systems. In FIG. 7, the binary value (Va1) of the digital electric input signal Va1 and the binary value (Va2) of the digital electric input signal Va2 are converted into a decimal value at 2-bit unit, and the difference from the immediately preceding 2-bits is described in a decimal value. The value of the immediate preceding 2 bits is 0 for the initial 2 bits.

When the difference from the immediately preceding 2 bits (1 bit of Va1 and 1 bit of Va2) increases, the transmission circuit 10 generates the first electric pulse signal having amplitude corresponding to a value of the difference, and thereby the first optical signal Ob1 is generated by the light emission element 20a. In addition, when the difference from the immediately preceding 2 bits decreases, the second electric pulse signal having amplitude corresponding to a value of the difference is generated, and thereby the second optical signal Ob2 is generated by the light emission element 20b. When the difference from the immediately preceding 2 bits is 0, the first and second electric pulse signals are not generated.

In FIG. 7, the first and second optical signals are defined as optical signals in which the amplitude is multiplexed by a value of 2²=4. More specifically, the amplitude at the time when the difference from the immediately preceding 2 bits is ±2 or ±3 is configured twice or three times of that at the time when the difference is ±1.

Next, when the reception circuit 50 receives the third electric pulse signal generated from the first optical signal Ob1 by the light reception element 40a, the reception circuit 50 changes the 2-system digital electric output signals for each bit in accordance with an amplitude value of the third electric pulse signal. In addition, when the reception circuit 50 receives the fourth electric pulse signal generated from the second optical signal Ob2 by the light reception element 40b, the 2-system digital electric output signals are changed for each bit in accordance with the amplitude value of the third electric pulse signal. If the third and fourth electric pulse signals are not received, 1 bit of the 2-system digital electric output signals that is the same as the immediately preceding 1 bit is outputted at predetermined timing. That is, in accordance with the amplitude values of the third and fourth electric pulse signals, the reception circuit 50 generates the 2-system digital electric output signals that increase or decrease for each bit at the 2-bit unit arranged in the order of the systems.

More specifically, at the initial 1 bit, as the amplitude of Ob1 is “2,” “00” is increased by “2” and becomes “10.” Thus, Vc1 is “1,” and Vc2 is “0.” At next 1 bit, as the amplitude of the Ob2 is “−1,” “10” is decreased by “1” and becomes “01,” Thus, Vc1 is “0,” and Vc2 is “1.” At next 1 bit, as the amplitude of Ob1 is “2,” “01” is increased by “2” and becomes “11.” Thus, Vc1 is “1,” and Vc2 is “1.”

In the optical transmission/reception circuit device of the present embodiment, the optical transmission is performed by comparing the N-system digital electric input signals for each bit at N-bit unit arranged in the order of the systems and by multiplexing the difference from the immediately preceding N bits in a 2^{N} value. As a result, the N-system digital electric input signals are optically transmitted with the first and second light emission elements and light reception elements. Therefore, reduction of power is possible compared with a case where the N-system digital electric input signals are optically transmitted with N number of light emission elements and light reception elements.

Further, with the light transmission/reception circuit device according to the present embodiment, because the N-system digital electric input signals is amplitude-multiplexed for each bit, the occurrence frequency of the optical signals is reduced compared with a case where the N-system digital electric input signals are time-multiplexed, thereby allowing the increase the speed (increase the number of systems) more easily.

In the optical transmission/reception circuit device of FIG. 6, when all of the N-system digital electric input signals are clock signal (010101 . . . ), the difference from the immediately preceding N bits is ±(2^{N}−1). Therefore, the amplitude of the first and second optical signals in such cases is the maximum, resulting in the largest power consumption. More specifically, when the smallest bit width of the N-system digital electric input signals is B, when the bit width of the first and second optical signals is b, and when the minimum amplitude value of the first and second optical signals (corresponding to the case when the difference from the immediately preceding N bits is ±1) is 1, the power of the optical signal per unit time is (2^{N}−1)·b/B because the first or second optical signal having the amplitude (2^{N}−1) are generated for each bit of the N-system digital electric input signals.

On the other hand, the power of the optical signal per unit time in the case when the above-described N-system digital electric input signals are optically transmitted with the N number of light emission elements and light reception elements using a direct modulation method that converts the digital electric input signal into the optical signal as is, is 0.5×N, which is the total mark ratios of the above-described N-system digital electric input signals, provided that the amplitude value of the optical signal is “1” that is equal to the minimum amplitude value for the first and second optical signals. As a result, the power of the optical signal is smaller than that using the direct modulation method if the bit width b of the first and second optical signals is configured smaller than N·B/{2·(2^{N}−1)}.

As discussed above, in the optical transmission/reception circuit device of the present embodiment, the optical transmission is performed by comparing the N-system digital electric input signals for each bit at N-bit unit arranged in the order of the systems and by multiplexing the difference from the immediately preceding N bits in a 2^{N} value, thereby allowing reduction of power.

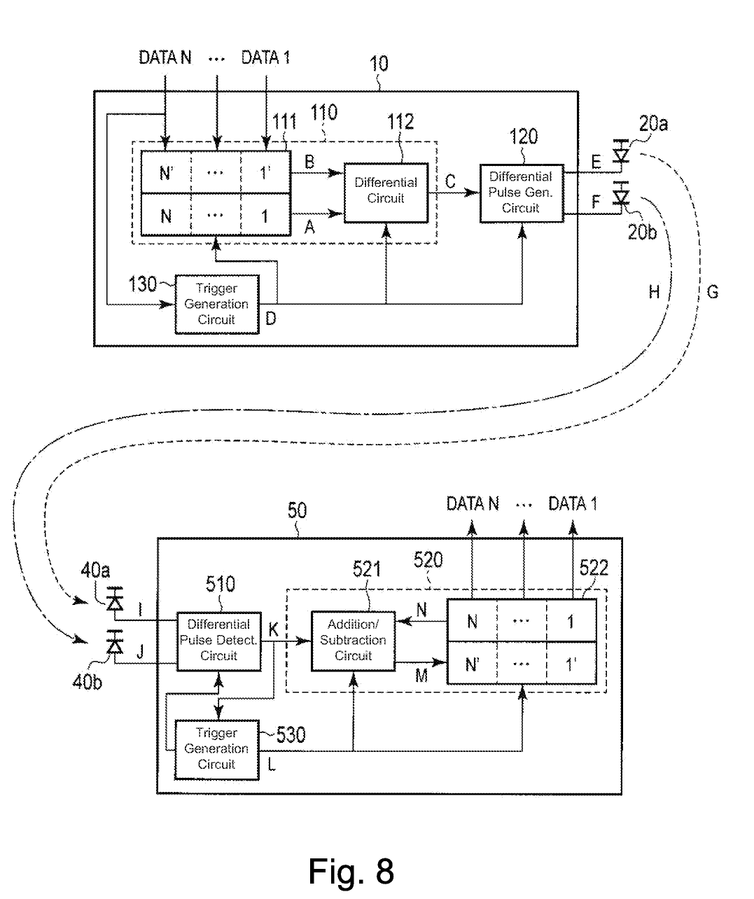

FIG. 8 illustrates a schematic block diagram showing an example of a specific configuration of the transmission circuit 10 and the reception circuit 50.

In the N-bit differential circuit 110 in the transmission circuit 10, the shift register 111 holds the N-system digital electric input signals by arranging each bit in the order of systems, in the order of reception. The differential circuit 112 compares the immediately preceding N bits (1, . . . , N) (A) and the current N bits (1′, . . . , N′) (B) held in the shift register 111 for each N bits (each bit of the N-system digital electric input signals) of the digital electric input signals and outputs a difference value (increase value and decrease value) (C) from the immediately preceding N bits.

The trigger generation circuit 130 of the transmission circuit 10 generates a trigger signal (D) based on the digital electric input signal. To perform the above-described operation, it is preferred that, in the transmission circuit 10, a trigger signal is inputted to the shift register 111, the differential circuit 112 and the differential pulse generation circuit 120 for each bit of the N-system digital electric input signals.

In the N-bit addition/subtraction circuit 520 in the reception circuit 50, the shift register 522 holds the N-system digital electric input signal arranged for each bit in the order of the systems and in the order for the transmission and transmits the N-system digital electric input signal sequentially. For each N bits of the digital electric output signal (for each bit of the N-system digital electric input signal), the addition/subtraction circuit 521 adds or subtracts the difference value (K) to or from the immediately preceding N bits (1, . . . N) (N) held in the shift register 522 and generates the next N bits (1′, . . . N) (M).

The trigger generation circuit 530 of the reception circuit 50 generates a trigger signal (L) based on the output of the differential pulse detection circuit 510. To perform the above-described operation, it is preferred that, in the reception circuit 50, a trigger signal is inputted to the differential pulse detection circuit 510, the addition/subtraction circuit 521 and the shift register 522 for each bit of the N-system digital electric input signals.

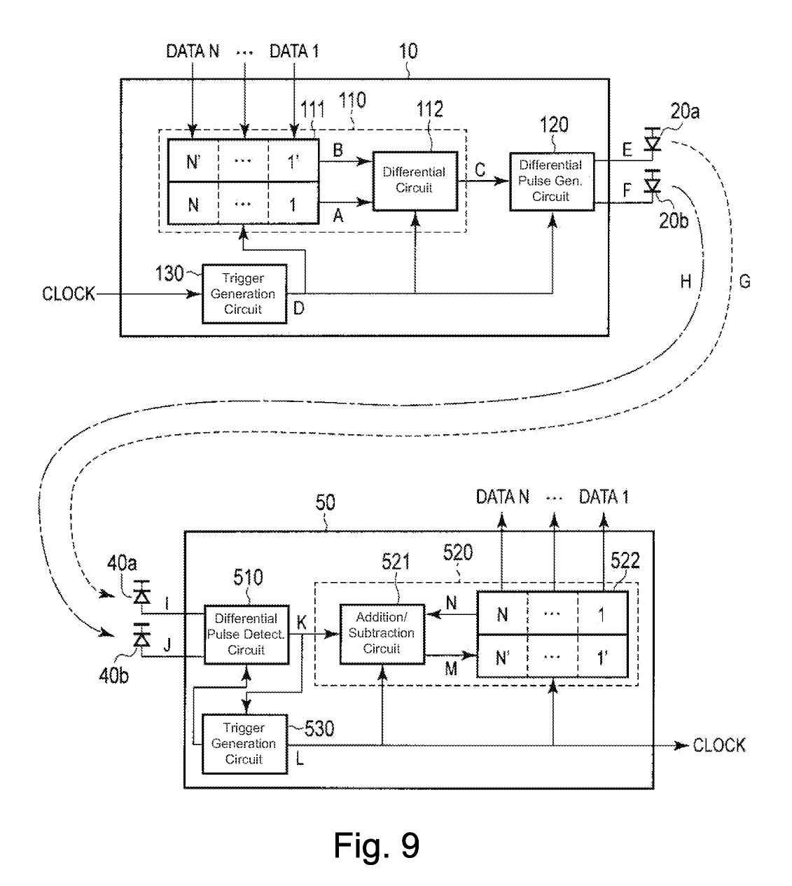

FIG. 8 illustrates an example in which the trigger signal is generated from the digital electric input signal at the transmission circuit 10. However, as shown in FIG. 9, a clock signal (CLOCK) that is synchronized with the digital electric input signal may be inputted externally to generate the trigger signal based on the received clock signal. Moreover, the trigger signal generated by the trigger generation circuit 530 in the reception circuit 50 may be outputted as the clock signal (CLOCK) that is synchronized with the digital electric output signal.

As described above, according to the present embodiment, each bit of the digital electric input signals Va1 and Va2 is compared at N bit unit arranged in the order of the systems. The first optical signal Ob1 is generated by multiplexing the amount of increase from the immediately preceding N bits to a 2^{N} value and is transmitted. Moreover. The second optical signal Ob2 is generated by multiplexing the amount of decrease from the immediately preceding N bits to a 2^{N} value and is transmitted. As a result, the occurrence frequency of the optical signals is reduced, thereby allowing reduction of the light emission amount for the optical transmission. Therefore, the low power optical transmission can be achieved.

### Modification Examples

The present disclosure is not limited to each of the above-described embodiments.

In FIGS. 1 and 6, the input signal of the transmission circuit 10 and the output signal of the reception circuit 50 are single-end signals. However, these signals may be differential signals.

In FIGS. 1, 4, 5, 6, 8 and 9 are schematic circuit diagrams illustrating that the light emission elements 20a and 20b and the light reception elements 40a and 40b are individually connected to the transmission circuit 10 and the reception circuit 50. However, various other connections are possible. For example, the light emission elements 20a and 20b may be series-connected (by connecting the cathode of the light emission element 20a and the anode of the light emission element 20b), and the connection point of the light emission elements 20a and 20b may be connected to the transmission circuit 10. Similarly, the light reception elements 40a and 40b may be series-connected (by connecting the anode of the light reception element 40a and the anode of the light reception element 40b), and the connection point of the light reception elements 40a and 40b may be connected to the reception circuit 50.

In FIGS. 4, 5, 8 and 9, arrows between each of circuit blocks merely schematically illustrate the connection between each of the circuit blocks, and thus the signal format and the number of signals are not limited by any means. For the actual circuit design, there may be other connections between the circuit blocks that are other than those illustrated in the figures of the present applications, or other circuit blocks may be newly provided.

The tight emission element 20 and the light reception element 40 are light emission element and the light reception element that are produced on a GaAs substrate, for example. The wavelength of the light emitted and received is 850 nm, for example. As the light emission element 20, a vertical cavity surface emitting laser (VCSEL), for example, is used. As the light reception element 40, a PIN photo diode (PD), for example, is used. The light emission element 20 and the light reception element 40 may be formed on a composite semiconductor (e.g., GaAlAs/GaAs, InGaAs/InP, SiGe and the like) or on a substrate of Si, Ge and the like. The wavelength of the light emitted or received may be appropriately changed as needed.

Moreover, as the tight emission element 20 and the light reception element 40, array chips, on which a plurality of light elements are formed within a single chip, or a photo semiconductor element on which both the tight emission element and the light reception element are formed in a single chip, may be used. Furthermore, a photo semiconductor element that is capable of both light emission and reception by a single element may be used. In addition, as the optical transmission path, an optical fiber, optical waveguide and the like can be used.

Further, an example of an optical transmission/reception circuit device that includes both of the transmission circuit and the reception circuit is explained in the present embodiments. However, the optical transmission/reception circuit device may be configured to include one of the transmission circuit and the reception circuit. That is, only the transmission circuit or the optical transmission circuit device that includes the transmission circuit having the light emission element can be produced. Similarly, only the reception circuit or the optical reception circuit device that includes the reception circuit having the light reception element can be produced. The tight emission element and the tight reception element may be chips separate from the transmission circuit and the reception circuit or may be integrated on the transmission circuit and the reception circuit.

The transmission circuit and the reception circuit may be a transmission/reception circuit (transceiver circuit) in which the transmission circuit and the reception circuit are integrated on a single chip.

While certain embodiments have been described, these embodiments have been presented by way of example only; and are not intended to limit the scope of the inventions. Indeed, the novel embodiments described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirits of the inventions.

What is claimed is:

1. An optical transmission circuit device, comprising:
a transmission circuit configured to generate differential set and reset signals each time digital electric input signals of N bits are received (N being an integer equal to or greater than 2), the differential set signal having a magnitude increase in the digital electric input signals from immediately preceding N bits multiplexed therein as a 2^{N} value and the differential reset signal having a magnitude decrease in the digital electric input signals from the immediately preceding N bits multiplexed therein as a 2^{N} value; and
a light emission element that is driven by the differential set signal and the differential reset signal.

2. The optical transmission circuit device of claim 1, wherein the transmission circuit is configured to generate one of the differential set signal, the differential reset signal, and no signal each time the digital electric input signals of N bits are received.

3. The optical transmission circuit device of claim 1, wherein the magnitude increase and decrease is represented by a magnitude of one of the differential set signal and the differential reset signal.

4. The optical transmission circuit device of claim 1, wherein the magnitude increase and decrease is represented by the number of the differential set signals or the number of the differential reset signals that are generated.

5. The optical transmission circuit device of claim 1, wherein the transmission circuit includes a differential circuit that is configured to compare the N bits to the immediately preceding N bits at every N bits of the digital electric input signals and output a differential value, and further comprising a differential pulse generation circuit that is configured to generate one of the differential set signal, the differential reset signal and no signal based on the differential value.

6. An optical reception circuit device, comprising:
a light reception element configured to provide a differential set signal having a magnitude increase in digital electric input signals of N bits from immediately preceding N bits multiplexed therein as a 2^{N} value and a differential reset signal having a magnitude decrease in the digital electric input signals from the immediately preceding N bits multiplexed therein as a 2^{N} value; and
a reception circuit configured to generate digital electric output signals of N bits at every N bits of the digital electric output signals by increasing the magnitude of the digital electric output signals of the immediately preceding N bits in accordance with the magnitude of the differential set signal and by decreasing the magnitude of the digital electric output signals of the immediately preceding N bits in accordance with the magnitude of the differential reset signal.

7. The optical reception circuit device of claim 6, wherein the magnitude increase and decrease is represented by a magnitude of one of the differential set signal and the differential reset signal.

8. The optical reception circuit device of claim 6, wherein the magnitude increase and decrease is represented by the number of the differential set signals or the number of the differential reset signals that are generated.

9. The optical reception circuit device of claim 6, wherein the reception circuit includes a differential pulse detection circuit that is configured to detect the magnitude increase or decrease of the digital electric input signals from immediately preceding N bits and an N bit addition/subtraction circuit that is configured to generate digital electric output signals of N bits by adding the detected magnitude increase to the digital electric output signals of the immediately preceding N bits or subtracting the detected magnitude decrease from the digital electric output signals of the immediately preceding N bits.

10. A method of communicating signals over an optical medium, comprising:
generating first and second electric signals each time digital electric input signals of N bits are received (N being an integer equal to or greater than 2), the first electric signal having a magnitude increase from immediately preceding N bits of the digital electric input signals that were received multiplexed therein as a 2^{N} value and the second electric signal having a magnitude decrease from the immediately preceding N bits of the digital electric input signals that were received multiplexed therein as a 2^{N} value; and
generating a first optical signal from the first electric signal and a second optical signal from the second electric signal and transmitting the first and second optical signals over the optical transmission medium.

11. The method of claim 10, wherein one of the first electric signal, the second electric signal and no signal is generated each time the digital electric input signals of N bits are received.

12. The method of claim 10, wherein the magnitude increase and decrease is represented by a magnitude of one of the first electric signal and the second electric signal.

13. The method of claim 10, wherein the magnitude increase and decrease is represented by the number of the first electric signals or the number of the second electric signals that are generated.

14. The method of claim 10, wherein said generating the first and second electric signals includes:
comparing the N bits to the immediately preceding N bits and outputting a differential value; and
generating one of the first electric signal and the second electric signal based on the differential value.

15. The method of claim 10, further comprising:
receiving the first optical signals and the second optical signals over the optical medium and generating third electric signals and fourth electric signals therefrom; and
generating digital electric output signals of N bits at every N bits of the digital electric output signals by increasing the magnitude of the digital electric output signals of the immediately preceding N bits in accordance with the magnitude of the third electric signal and by decreasing the magnitude of the digital electric output signals of the immediately preceding N bits in accordance with the magnitude of the fourth electric signal.

16. The method of claim 15, wherein said generating digital electric output signals includes:
detecting the magnitude increase or decrease in the digital electric signals from immediately preceding N bits; and
generating digital electric output signals of N bits by adding the detected magnitude increase to the digital electric output signals of the immediately preceding N bits or subtracting the detected magnitude decrease from the digital electric output signals of the immediately preceding N bits.
